(19) United States
(12) Patent Application Publication
(10) Pub. No.: US 2005/0036312 A1
(43) Pub. Date: Feb. 17, 2005

(54) Light emitting diode based lighting device

(75) Inventor: Ming-Te Lin, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: PARA LIGHT ELECTRONICS CO., LTD.

(21) Appl. No.: 10/640,013

(22) Filed: Aug. 14, 2003

(51) Int. Cl. F21S 13/14

(52) U.S. Cl. 362/252

(57) ABSTRACT

A light emitting diode (LED) based lighting device includes a plurality of circuit boards mounted to a base. Each circuit board has a curved or step-like edge contoured in correspondence to a particular curved surface. A plurality of sideways projecting LEDs is mounted along the curved edge of the circuit board. Thus, light from the LEDs is projected along a curved surface thereby particularly suitable for irregularly-shaped lighting devices having curved light projecting surfaces with low costs and simplified manufacturing process.

### FIELD OF THE INVENTION

The present invention generally relates to a light emitting diode (LED) based lighting device, and in particular to an LED lighting device having curved light projecting surface suitable for use with automobile lights, irregularly-shaped lights, traffic lights and lighting fixtures having curved light projecting surfaces.

### BACKGROUND OF THE INVENTION

A conventional LED lighting device comprises a circuit board on which a plurality of vertical LEDs are mounted for emission of light of sufficient intense. Such a configuration, however, is not fit for lighting devices that require curved light projecting surfaces.

Referring to FIG. 1 of the attached drawings, the conventional LED lighting device is not suitable for use in automobile lights. Heretofore, to employ the LED lighting device as an automobile light which has a generally curved light projecting surface, steel plates I having a shape and dimensions corresponding to a particular automobile light are made first, often by molding or other known techniques. LEDs 2 are then mounted to the steel plates I and the whole assembly comprised of the steel plates 1 and the LEDs 2 is then arranged in the automobile light. The LEDs 2 are arranged at different elevations on the steel plates 2 thereby allowing for projection of lights at different heights. Such an automobile, however, has a complicated and difficult manufacturing process and thus high costs. In addition, steel plates of different specifications must be made for each particular automobile light.

FIG. 2 of the attached drawings shows another example of the conventional LED lighting device, comprising a plurality of rectangular circuit boards 3 on each of which a plurality of vertical LEDs 4 are mounted. The circuit boards 3, with the LEDs 4 mounted thereon, are retained on a base 5 and oriented in selected directions whereby light can be projected in desired directions. However, the circuit board 3 itself is still a flat surface, not a curved surface. Thus, such a configuration of LED lighting device is still not suitable for curved light projecting surfaces.

Thus, it is desired to have an LED based lighting device that is suitable for curved light projecting surfaces.

### SUMMARY OF THE INVENTION

A primary object of the present invention is to provide an LED lighting device comprising a circuit board having a curved edge along which a plurality of LEDs are mounted in a sideways projecting manner whereby light from the LEDs is projected through and substantially distributed along a curved surface.

Another object of the present invention is to provide an LED lighting device comprising a circuit board having a curved edge along which a plurality of retainers are mounted for releasably receiving and retaining LEDs therein whereby mounting/dismounting the LEDs to the circuit board can be done easily and efficiently.

To achieve the above objects, in accordance with the present invention, there is provided an LED lighting device comprising a plurality of circuit boards mounted to a base. Each circuit board has a curved or step-like edge contoured in correspondence to a particular curved surface. A plurality of sideways projecting LEDs is mounted along the curved edge of the circuit board. Thus, light from the LEDs is projected through and substantially distributed along a curved surface thereby particularly suitable for irregularly-shaped lighting devices having curved light projecting surfaces with low costs and simplified manufacturing process.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a conventional LED lighting device;

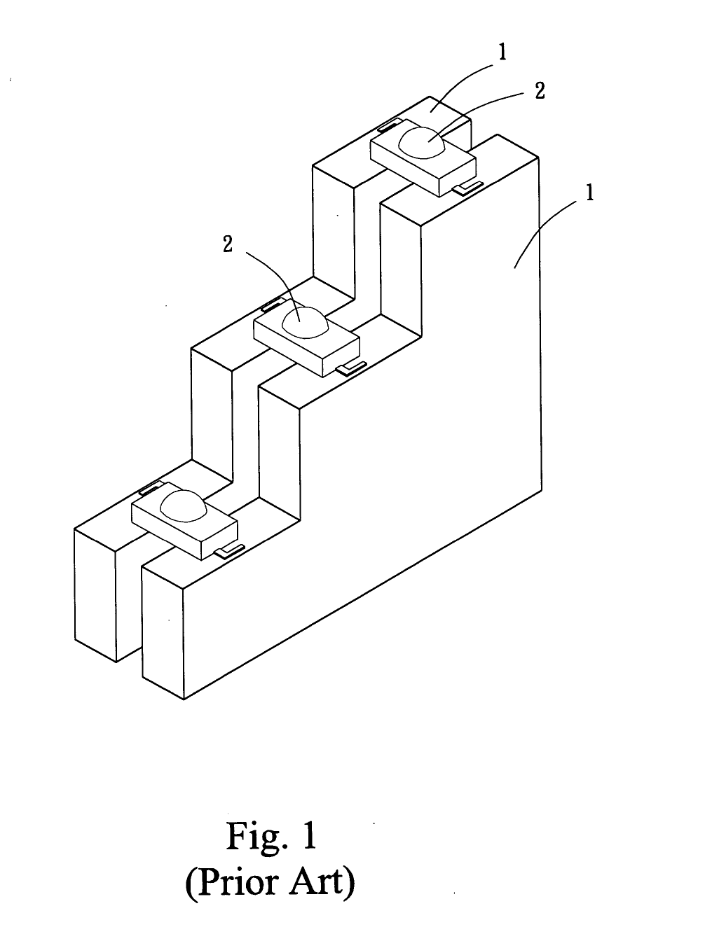

FIG. 2 is a perspective view of another conventional LED lighting device;

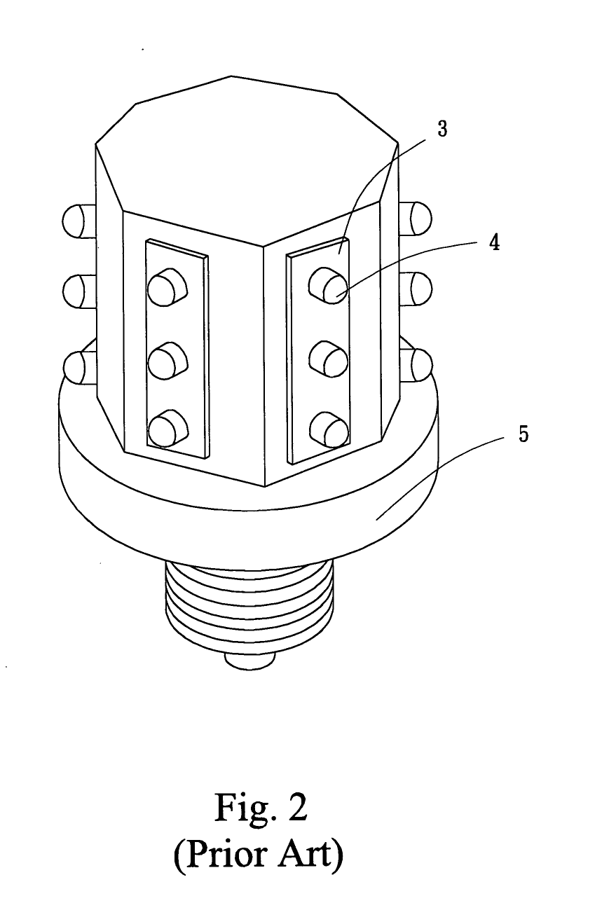

FIG. 3 is a plan view of an LED lighting device constructed in accordance with a first embodiment of the present invention;

FIG. 4 is a cross-sectional view showing the mounting of an LED to the circuit board in accordance with the present invention;

FIG. 5 is a cross-sectional view showing the mounting of an LED to the circuit board by means of a retainer in accordance with the present invention; and

FIG. 6 is a perspective view of an LED lighting device constructed in accordance with a second embodiment of the present invention.

### DETAILED DESCRIPTION OF THE PREFERRED EMBODIMENTS

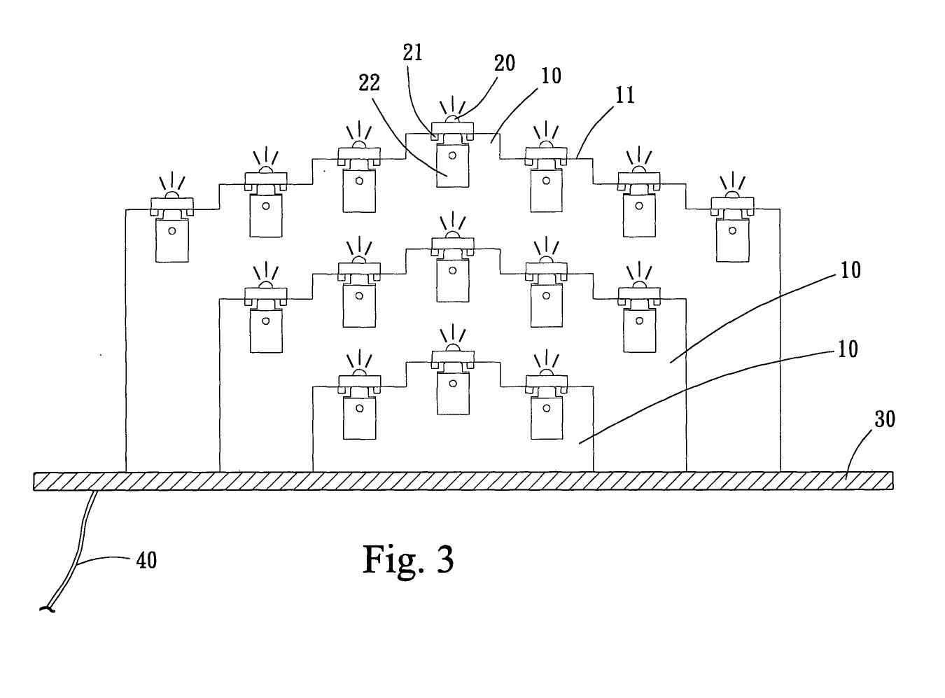

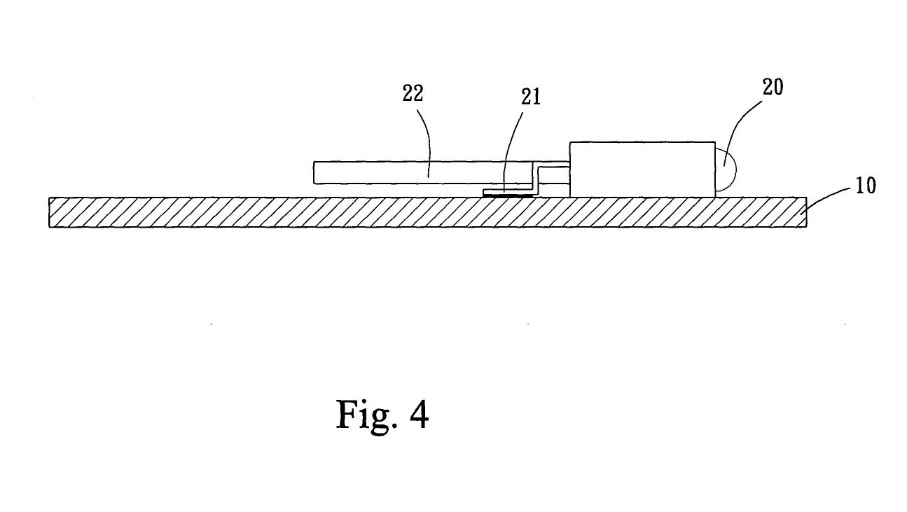

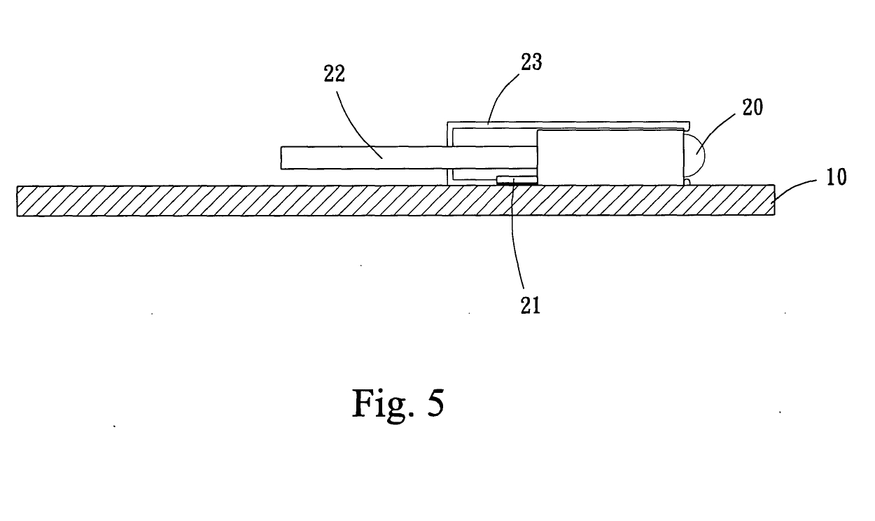

With reference to the drawings and in particular to FIGS. 3-5, a light emitting diode (LED) based lighting device constructed in accordance with the present invention comprises a plurality of circuit boards 10, each having a step-like edge 11 substantially corresponding to a curve contoured to be fit for a particularly and irregularly shaped lighting device. Apparently, the circuit board 10 may be actually formed with a curved edge, taking the place of the step-like edge. Thus, in the following description, the edge 11 of the circuit board 10 is regarded as curved edge for simplicity and convenience. A plurality of LEDs 20 is mounted to and spaced along the curved edge 11. The LEDs 20 are mounted to the circuit boards 10 in a sideways projecting manner, which allows light from each LED 20 to project in a sideways direction.

Each LED 20 has two conductive terminals 21 that are directly soldered to the circuit board 10 to form a sound connection therebetween. Each LED 20 also has a heat dissipation plate 22 extends rearward to facilitate dissipation of heat from the LED 20.

On each of the circuit boards 10, a plurality of retainers 23 are mounted along the curved edges thereof for receiving the LEDs 20. Thus, mounting/dismounting the LEDs 20 to/from the circuit boards 10 can be done readily and efficiently by fitting and removing the LEDs 20 into/from the corresponding retainers 23.

The LED lighting device of the present invention also comprises a base 30 having a top face (as observed in FIG. 3) to which the circuit boards 10 are mounted in a spaced manner and an opposite bottom face to which a cable 40 is mounted for supply of electricity to the circuit boards 10. Edges of the circuit boards 10 that are not attached to the base 30 form step-like or curved contour substantially corresponding to desired curves along which the LEDs 20 are distributed. Thus, a multiple layer (the circuit boards) and multiple orientation (the step-like contour) lighting device can be realized.

By means of the above described arrangement, the present invention provides sideways projecting LEDs 20 on a curved edge 11 of each circuit board 10 with the circuit boards 10 mounted to the base 30 at different locations whereby a multiple layer, multiple orientation and arbitrarily curved lighting device is realized. By means of the retainers 23 mounted along the curved edge, the LEDs 20 can be readily and efficiently connected to and/or disconnected from the circuit boards 10 by simply fitting into or withdrawn out of the retainers 23. Replacement of LEDs 20 can thus be readily done.

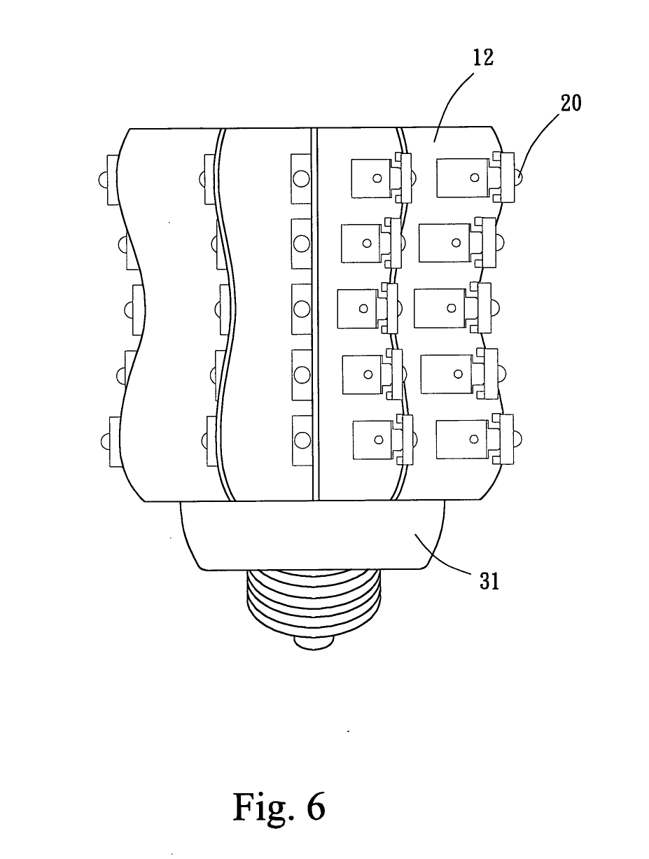

Also referring to FIG. 6, an LED lighting device in accordance with another embodiment of the present invention comprises a plurality of circuit boards 12 mounted on a base 31 in such a way that the circuit boards 12 are substantially radially extending from the base 31. Each circuit board 12 has a curved edge (not labeled) to which a plurality of LEDs 20 is mounted whereby the LEDs 20 are arranged in a curved pattern and fit for lighting device having curved surface.

Although the present invention has been described with reference to the preferred embodiments thereof, it is apparent to those skilled in the art that a variety of modifications and changes may be made without departing from the scope of the present invention which is intended to be defined by the appended claims.

1. A light emitting diode based lighting device comprising:
at least one circuit board having a curved edge;
a plurality of light emitting diodes mounted to the circuit board and along the curved edge;
a base to which the circuit board is mounted whereby a lighting device having arbitrary curved surface corresponding the curved edge is realized.

2. The light emitting diode based lighting device as claimed in claim 1, wherein each light emitting diode based lighting device has two conductive terminals directly soldered to the circuit board.

3. The light emitting diode based lighting device as claimed in claim 1 further comprising a retainer mounted to the edge of the circuit board for receiving and retaining the light emitting diode therein.

4. The light emitting diode based lighting device as claimed in claim 1 comprising a plurality of circuit boards mounted to the base and spaced from each other, each circuit board having a curved edge along which the light emitting diodes are mounted.

5. The shelf as claimed in claim 4, wherein the circuit boards are located at different elevations for corresponding to the curved edge of the circuit board.
